(19) United States
(12) Patent Application Publication
(10) Pub. No.: US 2026/0148061 A1
(43) Pub. Date: May 28, 2026

(54) SYSTEM AND METHOD FOR TRAINING MULTIMODAL BEHAVIOR PREDICTION MODEL

(71) Applicant: REALTEK SEMICONDUCTOR CORP., HSINCHU (TW)

(72) Inventor: KAI-HSIANG CHOU, HSINCHU (TW)

(21) Appl. No.: 19/049,045

(22) Filed: Feb. 10, 2025

(30) Foreign Application Priority Data
Nov. 26, 2024 (TW) 113145433

(51) Int. Cl. G06N 3/08; G06F 40/284; G06V 40/20

(52) U.S. Cl. CPC G06N 3/08; G06F 40/284; G06V 40/20

(57) ABSTRACT

A system and a method for training a multimodal behavior prediction model. The method is performed in a computing device that includes a processor and a neural processor. The processor retrieves multiple types of sensor data generated by one or more untrusted sensors and trusted sensors, and the neural processor uses multiple types of models corresponding to the multiple types of sensor data to predict behaviors of a user. The sensor data generated by the trusted sensors can be used to train the sensor data that are generated by the one or more untrusted sensors at the same time so as to train one or more prediction models. Therefore, the neural processor uses the trained prediction models and the trusted model to jointly establish the multimodal behavior prediction model that can be used to predict behaviors of the user and send a reminder for a specific event.

### CROSS-REFERENCE TO RELATED PATENT APPLICATION

This application claims the benefit of priority to Taiwan Patent Application No. 113145433, filed on Nov. 26, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method for training models by learning user behaviors, and more particularly to a system and a method for using multiple models and multiple sensors to learn user behaviors in order to train a multimodal behavior prediction model.

### BACKGROUND OF THE DISCLOSURE

People record important events in daily life in calendars or memorandums, but may often forget trivial things. The trivial things are such as turning off the gas stove when leaving the house, locking the car when exiting the vehicle, staying hydrated amidst daily routines, and watering the plants, etc. In particular, as our society gradually moves towards having an increasingly aging population, it may be necessary for elderly people to be reminded to take their medicine or do routine exercise frequently. Even if the above situations may not cause much trouble, one may not have confidence in their memory over time, and the risk of dementia may increase.

In some situations, taking exercise reminder as an example, the reminder can be achieved through tech. For example, a user can wear a sports bracelet or a smart watch that is equipped with a specific motion sensor to detect motions of the user by a cooperation of algorithms. Therefore, a number of times that a specific motion is repeated can be detected, and whether the number exceeds a preset threshold can be determined. However, there is no an effective reminder mechanism in the conventional technologies for things that should be done every day but are easy to forget.

### SUMMARY OF THE DISCLOSURE

For providing a solution that can effectively remind users things that they should be paying attention to in their daily lives, provided in the present disclosure is a system for training multimodal behavior prediction model and a method.

In one aspect of the system for training multimodal behavior prediction model, a computing device including a processor and a neural processor is provided, in which the processor obtains multiple types of sensing data generated by multiple sensors and the multiple sensors include one or more untrusted sensors and at least one trusted sensor, and the neural processor respectively applies multiple corresponding models to predict a user behavior based on the multiple types of sensing data for determining a key event. Thus, the sensing data with respective to the key event generated by the at least one trusted sensor can be obtained. For this key event, the sensing data to be generated by the one or more untrusted sensors at the same time can be used to train one or more prediction models.

The trusted sensor operates a trusted model having a probability of accurate prediction of the key event that is higher than a threshold. The prediction model operated in the untrusted sensor can be trained until probability of the prediction model predicting the key event is higher than a threshold.

Thus, in an aspect, the neural processor uses the trained one or more prediction models and the at least one trusted model to jointly establish a multimodal behavior prediction model that is used to predict the user behavior based on any or plurality of the multiple types of sensing data.

Further, the multiple types of sensing data generated by the multiple sensors include image sensing data generated by at least one image-retrieving device, sound sensing data retrieved by at least one audio-receiving device, and the sensing data generated by at least one user device.

Further, the image-retrieving device and the audio-receiving device are disposed in a scene and used to obtain images and sounds in the scene. The user device is a wearable sensor device or a mobile device worn by the user. A positioning circuit of the user device is used to obtain location of the user and a motion sensing circuit of the user device is used to obtain motions and actions of the user in the scene.

The above-mentioned multiple types of sensing data are mainly used to detect locations, motions and actions of the user. Through a trained prediction model and a trusted model, the user behavior can be predicted based on the multiple types of sensing data. A key event with repeatability or periodicity can be detected, and by which a reminder calendar can be established.

Further, when the one or more prediction models are obtained, the computing device can deploy the one or more prediction models or the multimodal behavior prediction model into the at least one edge-computing user device.

After that, the multiple types of sensing data generated by the multiple sensors are referred to for the multimodal behavior prediction model to predict the user behavior and determine the key event. After querying the reminder calendar, when the key event matches an event to be reminded in the reminder calendar, the user device generates a graphic or a sound to act as the reminder.

Further, the trusted model operated in the trusted sensor can be a large language model, and the prediction model operated in the untrusted sensor can be a trained language model. Still further, after the trusted sensor generates the sensing data, the sensing data is converted into the identifiable data for the large language model by a tokenization process; and, when the user behavior is predicted, the key event is labeled in the identifiable data and the labeled key events are used to train the trained language mode.

Furthermore, the trained language model is a model to be implemented by limiting operation of the large language model through a prompt, or a retrieval augmented generation model to be formed by limiting the large language model to predict a specific user behavior.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram illustrating a circumstance applying a system for training multimodal behavior prediction model according to one embodiment of the present disclosure;

FIG. 2 is a block diagram illustrating the system for training multimodal behavior prediction model according to one embodiment of the present disclosure;

FIG. 3 is a flowchart illustrating a method for training multimodal behavior prediction model according to one embodiment of the present disclosure;

FIG. 4 is a schematic diagram illustrating the system for training multimodal behavior prediction model and the method for operating the same according to one embodiment of the present disclosure;

FIG. 5 is a schematic diagram depicting a reminder calendar established by the multimodal behavior prediction model in one embodiment of the present disclosure; and

FIG. 6 is a schematic diagram depicting usage of the multimodal behavior prediction model to conduct reminder in one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to a system for training multimodal behavior prediction model and a method. In the method, a neural processor disposed in the system is namely a neural-network processing unit (NPU) that is used to perform artificial intelligence and machine learning algorithm to process multiple types of sensing data generated by multiple kinds of sensors and learn the features of the sensing data to train a multimodal model.

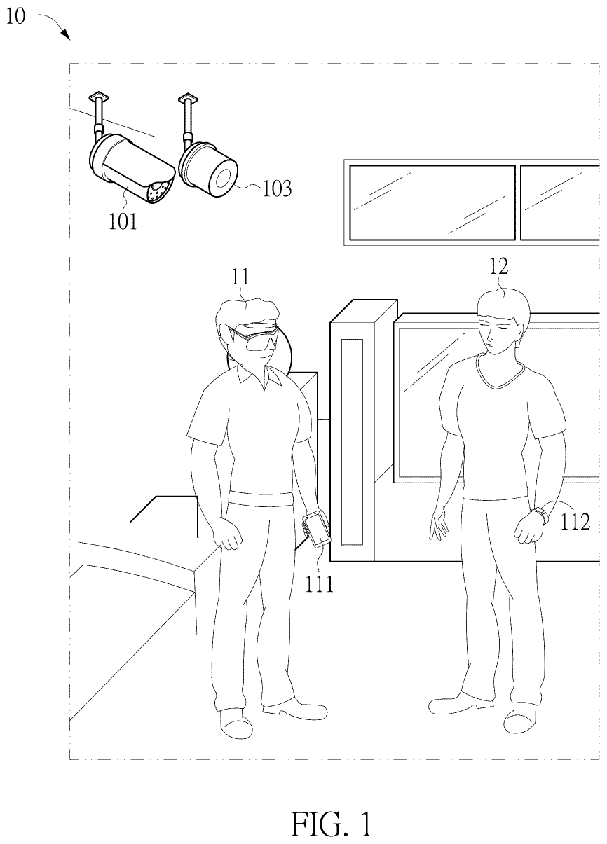

Reference is made to FIG. 1, which is a schematic diagram illustrating a circumstance applying the system for training multimodal behavior prediction model in one embodiment of the present disclosure. In this circumstance, several persons in a scene 10 that is equipped with an image-retrieving device 101, an audio-receiving device 103, and/or other various environmental sensors. The image-retrieving device 101 is used to capture continuous images of all of the persons (e.g., a first user 11 and a second user 12) in the scene 10. The audio-receiving device 103 is such as a microphone that can be used to record sounds generated in the scene 10.

Further, the first user 11 holds a mobile device 111. The mobile device 111 can be used to sense locations of the first user 11 through a positioning circuit (e.g., a GPS or the like) and sense motions of the first user 11 through a motion sensor. The sensing data is such as images that are captured by the image-retrieving device 101 that is such as a camera of the mobile device 111, and sounds that are recorded by the microphone. Accordingly, the various sensors can be used to acquire multimodal sensing data. The second user 12 wears a wearable sensor device 112 that can similarly be used to sense locations, motions, and/or other types of sensing data of the second user 12.

Thus, the system of the present disclosure uses at least one image-retrieving device 101 to capture image sensing data in the scene 10, uses at least one audio-receiving device 103 to acquire sound sensing data, and uses at least one user device (e.g., the mobile device 111 and the wearable sensor device 112) and other kinds of sensors to acquire various types of sensing data. The other kinds of sensors can be a positioning circuit that is used to acquire locations and a motion sensing circuit that is used to sense movement and actions of the user. A multimodal artificial intelligence model can learn user behaviors through the various sensing data.

According to one embodiment of the system for training multimodal behavior prediction model of the present disclosure, a large language model (LLM) is operated in the neural processor for tokenizing the multimodal sensing data generated by multiple sensors. The sensing data can be images, sounds, location information and time that are obtained for a specific behavior. The sensing data is tokenized to be the data being identifiable by the large language model. Any event in the sensing data can be manually labeled and used for learning the user behavior. The behavior with repeatability and periodicity can be determined from the sensing data, and by which a corresponding multimodal behavior prediction model and a timetable can be established. In addition to allowing the users to check whether or not an event has been completed at a time through images or sounds at any time, the system can remind the users what they should do at a predetermined time.

The action with periodicity is a user behavior that is repeated over time, and the repeated action can be referred to for establishing an event to be reminded periodically. The event to be reminded, for example, can be a reminder for sleeping, a reminder for waking up, a reminder for taking medicine after three daily meals, and a regular excise reminder. The behavior with repeatability indicates that the user behavior is not a periodic behavior but the behavior is repeatedly performed. Therefore, the behavior with repeatability can be learned by a machine learning process when training a model. For example, for the behaviors with repeatability, the related sensing data includes the images of the user entering or exiting a front door captured by a surveillance camera installed at home, the sounds of a door lock and the time can be used to train the multimodal behavior prediction model, and the multimodal behavior prediction model can be used to predict that the user is ready to go out by learning the various sensing data in the future. Further, the various reminders can be used to remind the user in various events. For example, the system uses voices, texts, vibrations and/or sounds generated by a mobile phone to remind the user some events such as switching off the gas, closing the door and remembering to carry keys.

It should be noted that some conventional technologies have provided some well-trained prediction models to correctly recognize objects, for example recognizing the front door and the door lock from the images near the front door to be captured at home by a specific large language model, but not determine the related behavior based on further sensing data (e.g., sounds or other). To this shortcoming, the system for training multimodal behavior prediction model and the method of the present disclosure provide a solution that uses a model with high accuracy recognition capability for a specific behavior to train another trainable model. Therefore, the purpose of multimodal behavior prediction and the following application for conducting reminders are achieved.

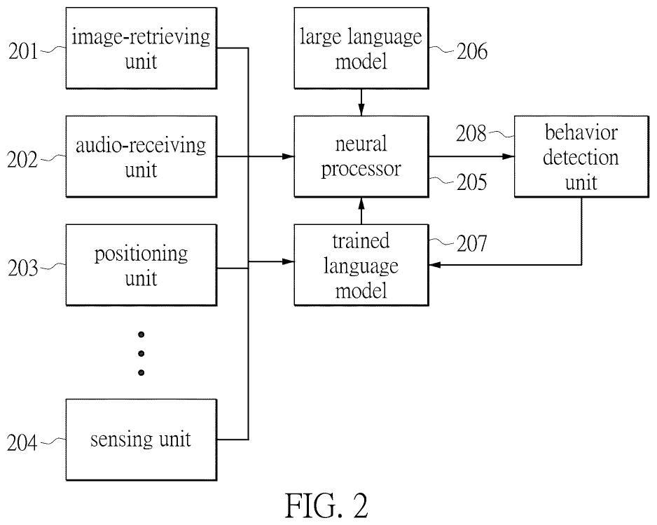

Reference is made to FIG. 2, which is a block diagram illustrating functions of the system for training multimodal behavior prediction model according to one embodiment of the present disclosure. The block diagram illustrates the circuitries and the functional elements that are implemented through collaboration of software and hardware (e.g., the processing circuits, memory and storage) of a computer system. The system uses the neural processor having an LLM with high accuracy recognition capability to train another trainable language model so as to establish a multimodal behavior prediction model being formed of one or more prediction models and at least one trusted model.

In one of the embodiments of the present disclosure, the system for training multimodal behavior prediction model can be implemented by a computing device, and the computing device includes a neural processor 205 that is configured to operate neural network models and machine-learning algorithms. The multiple kinds of sensors shown in the diagram include an image-retrieving unit 201, an audio-receiving unit 202, a positioning unit 203 and other sensing units 204. The sensors include at least one trusted sensor and at least one untrusted sensor. The sensors arranged in a scene are used to generate sensing data. The sensing data is processed by the neural processor 205. The sensing data generated by the trusted sensor with a probability of accurate prediction that exceeds a threshold can be used to train the sensing data generated by one or more untrusted sensors until the probability of the one or more prediction models to predict the key event exceeds the threshold, so that the one or more prediction models to be operated in the system can be established. Therefore, the trusted sensors and the untrusted sensor that operate the trained prediction models have the same or similar prediction capability when they are deployed in the scene.

In the present example, the image-retrieving unit 201 captures images of a scene. The images are processed by the neural processor 205 and the images are tokenized and converted into the data to be processed by a large language model 206. By a trained model, a user behavior can be accurately recognized and a key event can be determined by the large language model 206. For example, the key event can be a specific action performed by the user. In the meantime, the audio-receiving unit 202 generates sound data. The positioning unit 203 can generate positioning information at the same time. The positioning information can be expressed by a spatial coordinate position (e.g., x, y, z and time). Further, these sensing data can be combined with other sensing data that is generated by other sensing unit 204 at the same time. The other sensing unit 204 can be a mobile device handheld by the user or a wearable sensor worn by the user.

It should be noted that the sensing data generated by the image-retrieving unit 201 belongs to a trusted sensing data since the large language model 206 has a high confidence to accurately recognize the user behavior when processing the image data. When the sensing data is processed by the neural processor 205, the sensing data can be used to train the sensing data generated by the other untrusted sensor(s). In one of the embodiments of the present disclosure, a behavior detection unit 208 is used to label the key event detected from the user behavior, and the trusted sensing data can be obtained. The trusted sensing data can be used to train the untrusted sensing data by the neural processor 205 so as to obtain a trained language model 207 that is configured to be operated in the untrusted sensors. The untrusted sensing data can be continuously trained until the trained language model 207 can accurately recognize the user behavior and the confidence of determining the key event can reach the confidence of the large language model 206.

Afterwards, in the system for training multimodal behavior prediction model, the trained language model 207 having the same or similar accuracy with the large language model 206 can be used to assist the large language model 206 to operate and to establish a multimodal behavior prediction model with high accuracy recognition capability. The multimodal behavior prediction model can effectively recognize the user behavior and determine the key event(s). The key event(s) can be referred to for generating reminders.

It should be noted that the trained language model 207 can be a new large language model, or an augmented language model that is attached with the trusted large language model. For example, the trained language model 207 can be a large language model that is limited by a prompt to be established for a specific purpose and functions, or a retrieval augmented generation (RAG) model that is formed by limiting a large language model for predicting a specific user behavior. Furthermore, a domain adaption method such as Low-Rank Adaptation (LoRA) method is used to train a part of the large language model for constituting a small-scale language model with additional weights, and the small-scale language model can be used to recognize a specific user behavior.

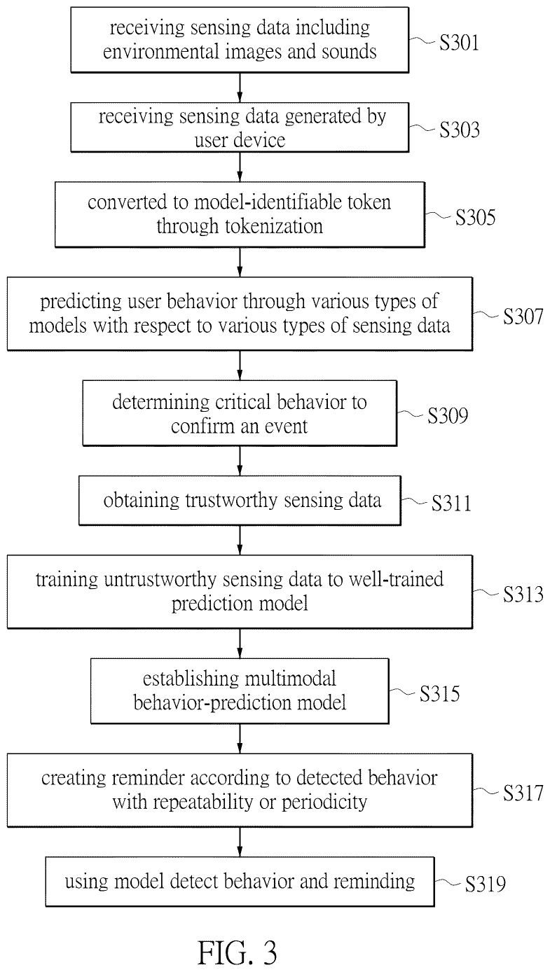

FIG. 3 is a flowchart illustrating a method for training multimodal behavior prediction model according to one embodiment of the present disclosure.

In the beginning, the system obtains multiple types of sensing data generated by a multimodal sensor that includes multiple sensors arranged in a scene. The sensing data includes environmental images and sounds that are generated at the same time (step S301), and the sensing data to be generated by various user devices at the same time (step S303). The multiple types of sensing data are generated by multiple sensors include image sensing data obtained by the at least one image-retrieving device, the sound sensing data obtained by the at least one audio-receiving device, and the sensing data generated by at least one user device.

The environmental images and sounds are respectively obtained by the image-retrieving device and the audio-receiving device of the system shown in FIG. 1 (or FIG. 2). The user device as shown in FIG. 1 is such as a wearable sensor worn on the user or the mobile device held by the user. The various kinds of sensors can be independently operated or installed inside a specific device and can generate the sensing data at the same time.

Next, the various types of sensing data can be tokenized to the tokens identifiable to models corresponding to the various type of sensing data (step S305). The system then employs multiple models with respect to the various types of sensing data to predict the user behavior (step S307). For example, the models using images to recognize the user behavior are used to recognize any or any combination of the locations, motions and actions of the user based on the image sensing data, and the models using audios to recognize the user behavior are used to recognize any or any combination of locations, motions and actions based on the sound sensing data. The prediction models can also be used to recognize any or any combination of location, motions and actions based on the sensing data generated by the user device.

The multimodal behavior prediction model operated in the system, for the user, relies on the multiple types of sensing data generated by the multiple sensors to predict the user behavior. The multiple sensors include one or more untrusted sensors and at least one trusted sensor. The system is disposed with a corresponding intelligent model for the at least one trusted sensor. The intelligent model is such as a large language model (LLM). The trusted sensor can be an edge-computing device that can operate a trusted model having a probability of accurate prediction exceeding a threshold for a key event. The trusted model performs a trusted behavior prediction, e.g., predicting the user behavior, according to the sensing data generated by the at least one trusted sensor.

On the other hand, the system, for the one or more untrusted sensors, is disposed with one or more corresponding trainable prediction models. The one or more prediction models can be operated in the one or more untrusted sensors. The prediction model can be used to predict the user behavior according to the sensing data generated by the one or more untrusted sensors. The user behavior to be predicted from the multiple types of sensing data can be referred to for determining at least one critical behavior (step S309). In certain embodiments, the behavior to be predicted from the trusted sensing data generated by the trusted sensor is referred to for determining the critical behavior.

After that, the system obtains the trusted sensing data from the at least one trusted sensor (step S311). The trusted sensing data with respect to the critical behavior can be used to train the untrusted sensing data that is generated for the same object by the one or more untrusted sensors at the same time so as to train one or more prediction models being operated in the one or more untrusted sensors. The one or more prediction models are continuously trained until a probability of predicting the key event exceeds the threshold (step S313).

Through the above-described flow, the one or more prediction models can be trained completely. The prediction models and the least one trusted model can jointly be used to establish a multimodal behavior prediction model (step S315). The multimodal behavior prediction model can rely on any or any combination of the multiple types of sensing data generated by the multiple sensors to predict the user behavior.

Next, the multimodal behavior prediction model or any of the models is used to predict the user behavior, and then establish an event to be reminded based on the detected behavior with repeatability or periodicity (step S317). For example, a reminder calendar can be established.

In one of the embodiments of the present disclosure, when the multimodal behavior prediction model is obtained, a computing device of the system is used to deploy the multimodal behavior prediction model into at least one edge-computing user device. After that, the multimodal behavior prediction model or any of the multiple prediction models can be used to predict the user behavior in a scene based on various types of sensing data, and also detect a key event. After querying the reminder calendar, when the key event matches one of the events to be reminded in the reminder calendar, at least one user device generates a graphic or a sound to act as a reminder. For example, a text, a voice or other reminder can be generated by the user device (step S319).

It should be noted that both the trained language model and the large language model that is trained by the sensing data generated by the trusted sensor(s) can generate the same or similar prediction result, and the probability of accurate prediction can exceeds the present threshold. Therefore, the trained models can be deployed to the user device for determining the user behavior. It is worth noting that the trained language model can be deployed to the edge-computing device (e.g., one of the sensors) that consumes less computing power, less electric power, and/or uses small amount of data.

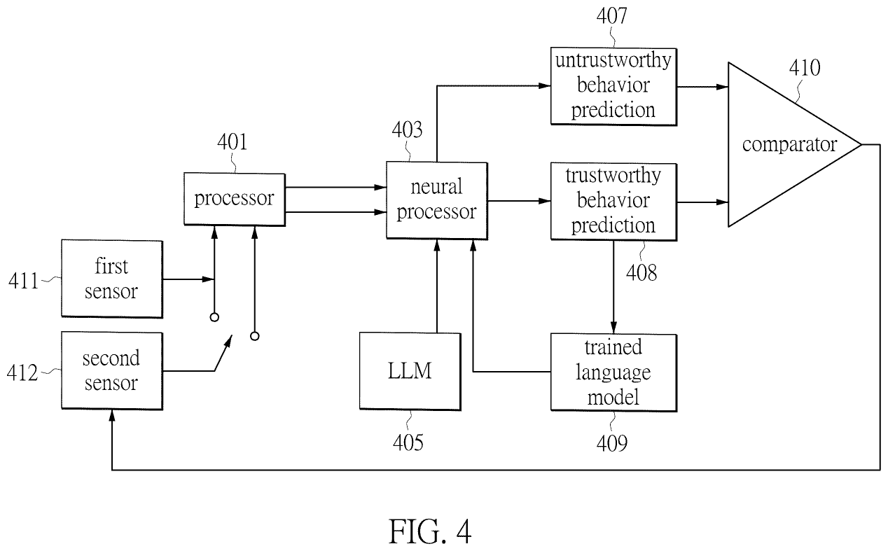

According to the above embodiments, in the system for training multimodal behavior prediction model, a trusted model operated in a trusted sensor can be a large language model, and a trained language model can be operated in an untrusted sensor. The method operated in the system refers to FIG. 4, which is a block diagram illustrating an operating method of the system according to one embodiment of the present disclosure.

A computing device operating the system for training multimodal behavior prediction model can be divided into a processor 401 that performs operations and processes data of a normal system and a neural processor 403 that operates a neural network model. The processor 401 firstly obtains sensing data generated by a trusted first sensor 411. The sensing data then undergoes a pre-processing process, for example the sensing data is converted to the data to be identifiable to a large language model through a tokenization process. The neural processor 403 operates a large language model 405 to process a trusted behavior prediction 408.

On the other hand, the processor 401 obtains untrusted sensing data generated by an untrusted second sensor 412. In a process of training the untrusted sensing data, the processor 401 performs the pre-processing process and converts the sensing data into the data identifiable to the large language model 405. The neural processor 403 relies on the trusted behavior prediction 408 to label the sensing data relating to a user behavior and a key event so as to perform an untrusted behavior prediction 407. The untrusted sensing data can therefore be trained for training a trained language model 409.

In the process of training the trained language model 409, a comparator 410 continuously compares a prediction result of the untrusted behavior prediction 407 and another prediction result of the trusted behavior prediction 408. When a difference between the above prediction results reaches a threshold preset by the system, it denotes that both the trained language model 409 and the large language model 405 have a similar confidence of predicting the user behavior and determining whether any key event occurs. The trained language model 409 forms a trusted prediction model. In the meantime, a trusted prediction result can be generated when the untrusted sensing data generated by the second sensor 412 is processed by the trained prediction model.

Thus, the prediction model trained by the neural processor 403 and the trusted model can jointly establish the multimodal behavior prediction model that is used to predict the user behavior based on any or any combination of the multiple types of sensing data.

For example, the trusted first sensor 411 operates a trusted model that for a key event has a probability of accurate prediction higher than a threshold. This trusted model is such as the large language model 405. The image sensing data generated by the first sensor 411 can be used to accurately recognize the user behavior by the large language model 405. However, the large language model 405 may not accurately recognize the user behavior based on the sound sensing data (that may be tokenized to the data identifiable to the large language model 405) generated by the second sensor 412. Thus, the neural processor 403 uses the labeled trusted image sensing data to train the untrusted sound sensing data generated by the second sensor 412 until the probability of the trained language model 409 accurately recognize the user behavior and predict the key event exceeds the threshold. The trusted prediction model that can accurately recognize the user behavior is established.

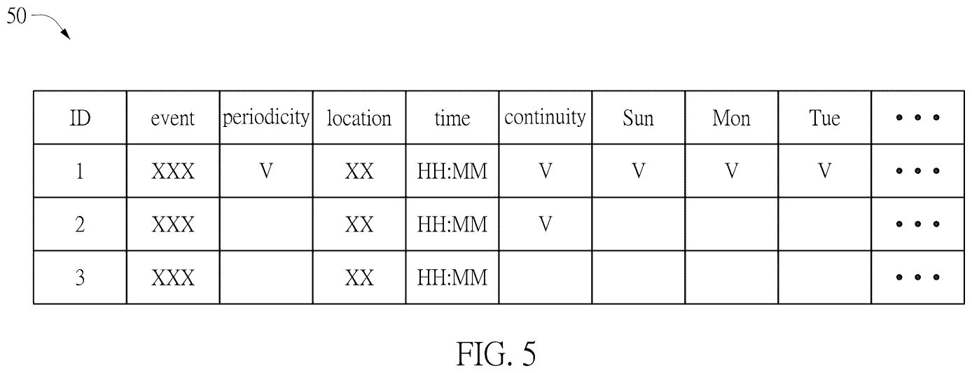

When the one or more prediction models and the as least one trusted model are trained completely by the above flow, the user behavior can be accurately predicted based on the multiple types of sensing data, and also the key event with repeatability or periodicity can be determined. Further, a reminder calendar can be established for the key event with repeatability or periodicity. Reference is made to FIG. 5, which is a schematic diagram depicting a reminder calendar 50 that is established by the multimodal behavior prediction model according to one embodiment of the present disclosure.

The reminder calendar 50 is exemplified for describing that a reminder is set based on an event with the characteristics of repeatability or periodicity. The prediction model that is trained by the above flow can be deployed by the computing device to an edge-computing sensor or a specific user device. A reminder calendar 50 that records events to be reminded can be established in the sensor or the user device.

When the prediction model is operated in the user device or the multimodal behavior prediction model is deployed in a scene, the prediction model or the multimodal behavior prediction model can rely on the multiple types of sensing data generate by the multiple sensors to predict the user behavior and determine the key event. After comparing with the reminder calendar, a reminder is generated. For example, the user device generates the reminder through a graphic, texts or a sound.

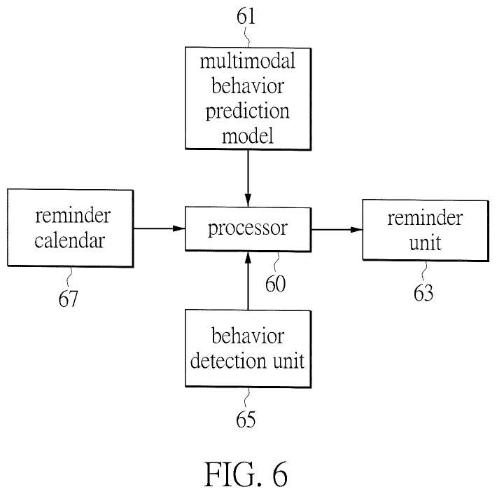

FIG. 6 is a schematic diagram illustrating a multimodal behavior prediction model that is implemented through collaboration of hardware and software of a computer system for preforming reminder in one embodiment of the present disclosure.

The computing device includes a processor 60 that is used to operate a multimodal behavior prediction model 61 and a processor 60 (e.g., a processor of an edge-computing device) that can be a microprocessor of an edge-computing device. The computing device uses a multimodal sensor of a behavior detection unit 65 is used to obtain sensing data in a scene. The multimodal behavior prediction model 61 is used to process multiple types of sensing data (e.g., images, sounds, locations and time) so as to predict the user behavior. It should be noted that the large language model operated in the system can be used to predict the user behavior directly, or a trained model assists in predicting the user behavior, or a sensor can itself perform edge-computing. The model with a probability of accurate prediction higher than the threshold operated in the edge-computing device is used to predict the user behavior.

A reminder calendar 67 records one or more events to be reminded. The event to be reminded is established by the multimodal behavior prediction model 61 when a corresponding event with repeatability or periodicity is detected by the behavior detection unit 65. The processor 60 compares the predicted user behavior with the events to be reminded in the reminder calendar 67. If the predicted user behavior matches the event to be reminded, a reminder unit 63 generates a reminder through a voice, texts or vibration.

In conclusion, according to the above embodiments of the system for training multimodal behavior prediction model and the method, one of the main technical concepts is that the multiple kinds of sensor generate multiple types of sensing data for an event, the trusted data is used to train the trusted data so as to train a model capable of predicting the user behavior. A multimodal behavior prediction model is accordingly established for generating a reminder for a key event.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for training multimodal behavior prediction model, operated in a computing device, comprising:
receiving, with respect to a user, multiple types of sensing data generated by multiple sensors, wherein the multiple sensors include one or more untrusted sensors and at least one trusted sensor;
respectively applying multiple models corresponding to the multiple types of sensing data to predict a user behavior for determining a key event;
obtaining, with respect to the key event, the sensing data generated by the at least one trusted sensor, wherein a probability of at least one trusted model operated in the at least one trusted sensor predicting the key event is higher than a threshold; and
applying the sensing data generated by the at least one trusted sensor to train the sensing data generated by the one or more untrusted sensors with respect to the key event at a same time so as to train one or more prediction models operated in the one or more untrusted sensors until a probability of the one or more prediction models predicting the key event is higher than the threshold.

2. The method according to claim 1, wherein the multiple types of the sensing data generated by the multiple sensors include image sensing data that is acquired by the at least one image-retrieving device, sound sensing data that is obtained by the at least one audio-receiving device, and the sensing data generated by at least one user device.

3. The method according to claim 2, wherein the at least one image-retrieving device and the at least one audio-receiving device are disposed in a scene and used to obtain images and sounds in the scene; and the user device is a wearable sensor device or a mobile device worn by the user; wherein, a positioning circuit of the user device is used to obtain location of the user and a motion sensing circuit of the user device is used to obtain motions and actions of the user in the scene.

4. The method according to claim 2, wherein the multiple types of sensing data are used to detect locations, motions and actions of the at least one user.

5. The method according to claim 4, wherein the trained one or more prediction models and the at least one trusted models rely on the multiple types of sensing data to predict the user behavior, determine the key event with repeatability or periodicity, and establish a reminder calendar with respect to the key event with repeatability or periodicity.

6. The method according to claim 5, wherein the one or more prediction models rely on the multiple types of sensing data generated by the multiple sensors to predict the user behavior so as to obtain the key event and generate a reminder according to the reminder calendar.

7. The method according to claim 6, wherein, when the key event matches an event to be reminded in the reminder calendar, the at least one user device generates a graphic or a sound as the reminder.

8. The method according to claim 1, wherein the trained one or more prediction models and the at least one trusted model are jointly used to establish a multimodal behavior prediction model that is used to predict the user behavior based on any one or a plurality of the multiple types of sensing data.

9. The method according to claim 8, wherein the trusted model operated in the trusted sensor is a large language model, and the prediction model operated in the untrusted sensor is a trained language model; wherein, after the trusted sensor generates the sensing data, the sensing data is converted into the identifiable data for the large language model by a tokenization process; and, when the user behavior is predicted, the key event is labeled in the identifiable data and the labeled key events are used to train the trained language model.

10. The method according to claim 9, wherein the trained language model is a model to be implemented by limiting operation of the large language model through a prompt, or a retrieval augmented generation model to be formed by limiting the large language model to predict a specific user behavior.

11. A system for training multimodal behavior prediction model, comprising:
a computing device, including a processor and a neural processor;
wherein the processor obtains multiple types of sensing data generated by multiple sensors, wherein the multiple sensors include one or more untrusted sensors and at least one trusted sensor;
wherein the neural processor respectively applies multiple models corresponding to the multiple types of sensing data to predict a user behavior and determines a key event; the sensing data generated by the at least one trusted sensor with respect to the key event are obtained and used to train the sensing data generated by the one or more untrusted sensors for the key event at a same time so as to train one or more prediction models; and
wherein the at least one trusted sensor operates at least one trusted model that, with respect to the key event, has accurate prediction probability higher than a threshold, and the one or more prediction models operated in the one or more untrusted sensors are trained until a probability of the one or more prediction models predicting the key event is higher than the threshold.

12. The system according to claim 11, wherein the multiple types of the sensing data generated by the multiple sensors include image sensing data that is acquired by the at least one image-retrieving device, sound sensing data that is obtained by the at least one audio-receiving device, and the sensing data generated by at least one user device.

13. The system according to claim 12, wherein the at least one image-retrieving device and the at least one audio-receiving device are disposed in a scene and used to obtain images and sounds in the scene; and the user device is a wearable sensor device or a mobile device worn by the user; wherein, a positioning circuit of the user device is used to obtain location of the user and a motion sensing circuit of the user device is used to obtain motions and actions of the user in the scene.

14. The system according to claim 12, wherein the multiple types of sensing data are used to detect locations, motions and actions of the at least one user.

15. The system according to claim 14, wherein the trained one or more prediction models and the at least one trusted models rely on the multiple types of sensing data to predict the user behavior, determine the key event with repeatability or periodicity, and establish a reminder calendar with respect to the key event with repeatability or periodicity.

16. The system according to claim 15, wherein, when the one or more prediction models are obtained, the computing device deploys the one or more prediction models into the at least one edge-computing user device.

17. The system according to claim 16, wherein the one or more prediction models rely on the multiple types of sensing data generated by the multiple sensors to predict the user behavior so as to obtain the key event and generate a reminder according to the reminder calendar; wherein, when the key event matches an event to be reminded in the reminder calendar, the at least one user device generates a graphic or a sound as the reminder.

18. The system according to claim 11, wherein the neural processor uses the trained one or more prediction models and the at least one trusted model to jointly establish a multimodal behavior prediction model that is used to predict the user behavior based on any or plurality of the multiple types of sensing data.

19. The system according to claim 18, wherein the trusted model operated in the trusted sensor is a large language model, and the prediction model operated in the untrusted sensor is a trained language model; wherein, after the trusted sensor generates the sensing data, the sensing data is converted into the identifiable data for the large language model by a tokenization process; and, when the user behavior is predicted, the key event is labeled in the identifiable data and the labeled key events are used to train the trained language mode.

20. The system according to claim 19, wherein the trained language model is a model to be implemented by limiting operation of the large language model through a prompt, or a retrieval augmented generation model to be formed by limiting the large language model to predict a specific user behavior.
